(19) United States
(12) Patent Application Publication
(10) Pub. No.: US 2009/0295794 A1
(43) Pub. Date: Dec. 3, 2009

(54) METHOD FOR CONTROLLING OPERATING MODES OF GRAPHICS PROCESSING UNIT

(75) Inventors: SHENG-SHIUAN FAN, Taipei (TW); LI-CHUN CHUNG, Taipei (TW)

Correspondence Address: WPAT, PC;INTELLECTUAL PROPERTY ATTORNEYS, 7225 BEVERLY ST., ANNANDALE, VA, 22003, US

(73) Assignee: ASUSTeK COMPUTER INC., Taipei (TW)

(21) Appl. No.: 12/437,389

(22) Filed: May 7, 2009

(30) Foreign Application Priority Data
May 30, 2008 (TW) 097120283

(51) Int. Cl. G06F 15/80; G06T 15/00

(52) U.S. Cl. 345/419; 345/505

(57) ABSTRACT

An operating mode controlling method is used with a graphics processing unit of a computer system. The graphics processing unit includes a plurality of stream processors. The operating mode controlling method includes the following steps. Firstly, an operating status of the computer system is detected, thereby determining a normal-operating mode or a power-saving mode of the graphics processing unit. If the graphics processing unit is operated in the normal-operating mode, all of the stream processors are enabled. If the graphics processing unit is operated in the power-saving mode, some of the stream processors are enabled.

### FIELD OF THE INVENTION

The present invention relates to a method for controlling a graphics processing unit, and more particularly to a method for controlling operating modes of a graphics processing unit.

### BACKGROUND OF THE INVENTION

In modern computer systems, graphics cards play very important roles in order for meeting increasingly visual demands in many applications such as operating systems, 3D applications, games or multimedia applications. Generally, a graphics processing unit (GPU) is the heart of a graphics card. Modern GPUs are very efficient at manipulating and displaying computer graphics. Increasing development makes GPUs more effective than general-purpose CPUs for a range of complex algorithms.

Since 3D games or 3D multimedia are now rapidly gaining in popularity, the demand on GPU becomes stringent. In contrast with CPU, GPU is a specialized processor with advanced image processing capabilities in the modern computer system. In the early stage, the 2D video chip relies on CPU to process 3D images to implement a so-called software acceleration function. Nowadays, the 3D video chip has a hardware acceleration function for effectively processing 3D images and special effects.

As the processing power of GPU increases, the demand for electrical power increases. Generally, high performance GPU often consumes more energy than current CPU. Conventionally, reduction of working clock or operating voltage is helpful for reducing energy consumption. As the working clock or operating voltage is reduced, the working speed of GPU becomes slow. Nowadays, the GPU manufacturers make efforts in designing novel power-saving means of reducing the GPU's energy consumption.

As known, a hybrid power technology is the NVIDIA's latest solution to combat the rising power consumption. The hybrid power technology allows a system with a motherboard and a graphics card to work together to provide on-demand graphics power. The graphics core on the motherboard is communicated with the discrete GPU via a system management bus (SMBUS). When the computer is under a light load, the discrete GPU will be turned off entirely via the SMBUS, and all rendering will be handled by the graphics core. If more GPU power is required, the SMBUS will wake up the discrete GPU and rendering will be taken over by the discrete GPU.

FIG. 1 is a schematic functional block diagram illustrating the architecture of a computer system using a NVIDIA hybrid power technology. The computer system using a NVIDIA hybrid power technology comprises a motherboard 11, a central processing unit (CPU) 13, a built-in graphics core 15 and a discrete graphics processing unit (GPU) 17. Via the SMBUS, the motherboard 11 could turn on or turn off the discrete GPU 17. In a case that the graphics function of the computer system is under a light load, the discrete GPU is automatically or manually turned off via the SMBUS, and the associated graphics computations are taken over by the built-in graphics core 15. Under this circumstance, the discrete GPU 17 nearly consumes no electrical energy. For an advanced graphics card, the energy reduction is about 70˜90 Watt and thus the overall energy consumption is reduced. If more GPU power is required for performing the 3D graphics operations, the SMBUS will wake up the discrete GPU 17 to perform associated 3D graphics operations. The computer system using the hybrid power technology of FIG. 1 could achieve the power-saving purpose without deteriorating the graphics performance.

Furthermore, a major designer and supplier of graphics processing units, ATI, disclosed a power-on-demand technology. The power-on-demand technology could dynamically adjust the operating voltages under the load of GPU. By using the power-on-demand technology, GPU is able to stably work at a voltage as low as 0.95V and thus the power consumption is largely reduced. By cooperating with transistors at different operating voltages and providing an improved data path, GPU could work at a low clock to achieve the power-saving purpose.

### SUMMARY OF THE INVENTION

The present invention provides a method for controlling operating modes of a graphics processing unit so as to reduce energy consumption of the graphics processing unit.

In accordance with an aspect of the present invention, there is provided an operating mode controlling method for use with a graphics processing unit of a computer system. The graphics processing unit includes a plurality of stream processors. The operating mode controlling method includes the following steps. Firstly, an operating status of the computer system is detected, thereby determining a normal-operating mode or a power-saving mode of the graphics processing unit. If the graphics processing unit is operated in the normal-operating mode, all of the stream processors are enabled. If the graphics processing unit is operated in the power-saving mode, some of the stream processors are enabled.

In accordance with another aspect of the present invention, there is provided a graphics processing unit of a computer system. The graphics processing unit includes an input assembler, a thread execution managing unit, a plurality of stream processors, a plurality of parallel data caches, a load/store unit, and a frame buffer. The input assembler receives a graphics data and dividing the graphics data into a plurality of threads. The thread execution managing unit for receives and manages the threads. The stream processors are connected with the thread execution managing unit. A specified number of stream processors are enabled according to an operating status of the computer system. The threads from the thread execution managing unit are received and processed by the enabled stream processors, thereby outputting processed graphics data. The parallel data caches are connected with respective stream processors for temporarily storing the processed graphics data outputted from the stream processors. The load/store unit receives the processed graphics data. The frame buffer is connected with the load/store unit.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic functional block diagram illustrating the architecture of a computer system using a NVIDIA hybrid power technology;

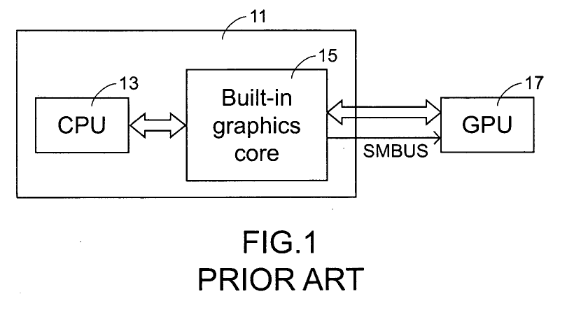

FIG. 2 is a schematic functional block diagram illustrating a graphics processing unit using an operating mode control method of the present invention; and

FIG. 3 schematically illustrates a flowchart of an operating mode controlling method for use with the graphics processing unit according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

As previously, the conventional power-saving means of reducing the GPU's energy consumption is based on the reduction of working clock or operating voltage. According to the present invention, the stream processors of the graphics processing unit are partially or all enabled according to the operating status of the computer system, thereby achieving the power-saving purpose.

As known, a modern GPU comprises several tens to several hundreds of parallel processing units to process graphic data in parallel. Due to the parallel processing, the GPU run faster. The parallel processing units are also referred as stream processors.

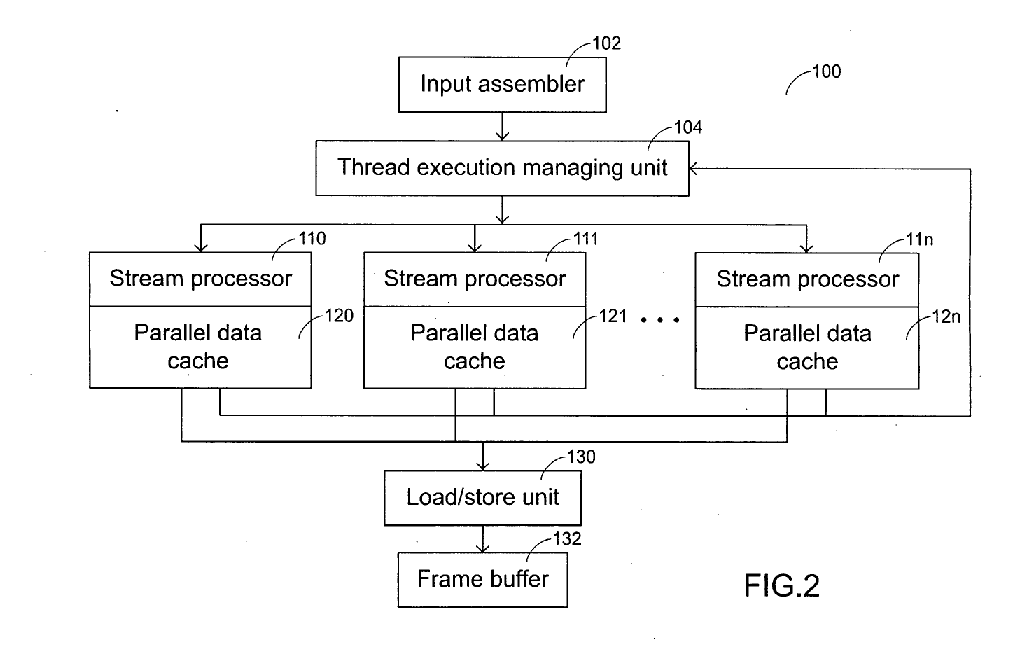

FIG. 2 is a schematic functional block diagram illustrating a graphics processing unit using an operating mode control method of the present invention. The graphics processing unit is based on the architecture of a NVIDIA G92 chip. As shown in FIG. 2, the graphics processing unit 100 comprises an input assembler 102, a thread execution managing unit 104, a plurality of stream processors 110˜11n, a plurality of parallel data caches 120˜12n, a load/store unit 130 and a frame buffer 132.

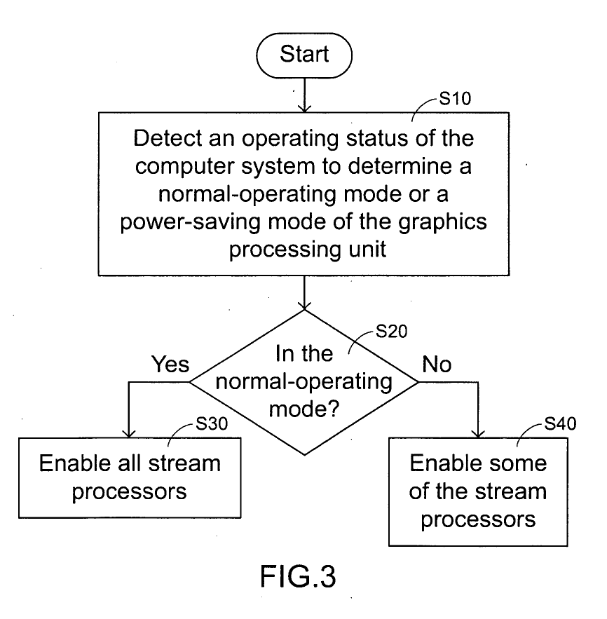

When a graphics command and corresponding graphics data are received by the graphics processing unit 100, the input assembler 102 gives a unique thread ID for each thread. By the thread execution managing unit 104, different threads received by the graphics processing unit 100 are classified into Vtx thread issues, Geom thread issues and Pixel thread issues. According to the operating status of the computer system, the graphics processing unit enters a normal-operating mode or a power-saving mode (see FIG. 3) and thus a specified number of stream processors will be dynamically enabled. When the number of stream processors to be enabled is decided, the thread execution managing unit 104 will allocate the threads to corresponding stream processors 110˜11n in order to process the graphics data in parallel. The processed graphics data are temporarily stored in the parallel data caches 120˜12n.

The processed graphics data stored in the parallel data caches 120˜12n could be further allocated by the thread execution managing unit 104. Alternatively, the processed graphics data stored in the parallel data caches 120˜12n could be transmitted to the load/store unit 130 and then stored in the frame buffer 132 in order for display.

FIG. 3 schematically illustrates a flowchart of an operating mode controlling method for use with the graphics processing unit according to the present invention. First of all, an operating status of the computer system is detected in order to determine a normal-operating mode or a power-saving mode of the graphics processing unit (Step S10). If the graphics processing unit is operated in the normal-operating mode (Step S20), all stream processors are enabled (Step S30). Whereas, if the graphics processing unit is operated in the power-saving mode, some of the stream processors are enabled (Step S40).

Likewise, the stream processors are cores of the graphics processing unit of the present invention for processing graphics data in parallel. In accordance with a feature of the present invention, a specified number of stream processors will be dynamically enabled according to the operating status of the computer system in order to achieve the power-saving purpose.

In a case that the graphics function of the computer system is under a light load, some of the stream processors are automatically or manually disabled in order to reduce energy consumption. Alternatively, the stream processors are disabled according to the settings of the registers.

Take a manual control for example. When the computer system is under a light load (e.g. execution of word processing), the user may manually disable some of the stream processors via a user interface such that the graphics processing unit enters the power-saving mode. Assuming that there are 64 stream processors in the graphics processing unit, the user may manually disable some of the stream processors via the user interface because enabling all stream processors results in energy waste and is not useful to increase the word processing performance. The number of stream processors to be enabled or disabled is dependent on the tasks implemented by the computer system. For example, 32 stream processors could be disabled because the adverse influence on the word processing performance is negligible. Under this circumstance, the power-saving purpose is achieved. On the other hand, when the computer system is under a heavy load (e.g. execution of 3D multimedia processing), the user may manually enable all stream processors via the user interface such that the graphics processing unit enters the normal-operating mode. Meanwhile, the 64 stream processors are all enabled to enhance the 3D multimedia processing performance.

Take an automatic control for example. The number of stream processors to be enabled or disabled is also dependent on the tasks implemented by the computer system. When the computer system is under a heavy load (e.g. execution of 3D multimedia processing), all of 64 stream processors are automatically enabled to enhance the 3D multimedia processing performance. Whereas, when the computer system is under a light load (e.g. execution of word processing), 32 stream processors are automatically enabled but 32 stream processors are automatically disabled such that the graphics processing unit enters the power-saving mode.

Since GPU and CPU intimately cooperate with each other in some aspects, the number of stream processors to be enabled is decided according to the working load of the CPU of the computer system. For example, if the operation of the CPU is under a heavy load, all stream processors are automatically enabled such that the graphics processing unit enters the normal-operating mode. As a consequence, the optimal performance of the GPU of the present invention is fully demonstrated to partially share the loading on the CPU. Whereas, if the operation of the CPU is under a light load, some stream processors (e.g. 32 stream processors) are automatically disabled such that the graphics processing unit enters the power-saving mode. Under this circumstance, the power-saving purpose is achieved without deteriorating the graphics performance.

Furthermore, the number of stream processors to be enabled is decided according to the temperature of the graphics processing unit. If the temperature of the graphics processing unit is higher than a threshold value, it is meant that the graphics processing unit is under the heavy load. Meanwhile, all stream processors are automatically enabled such that the graphics processing unit enters the normal-operating mode so as to demonstrate the optimal performance of the GPU. Whereas, if the temperature of the graphics processing unit is lower than the threshold value, it is meant that the graphics processing unit is under the light load. Meanwhile, some stream processors (e.g. 32 stream processors) are automatically disabled such that the graphics processing unit enters the power-saving mode. Under this circumstance, the power-saving purpose is achieved without deteriorating the graphics performance.

From the above description, the number of stream processors to be enabled is decided according to the operating status of the computer system, so that the operating mode controlling method of the present invention can dynamically achieve the power-saving purpose. In the above embodiments, the number of stream processors to be enabled is dependent on whether the 3D multimedia processing operation is executed, whether the CPU is under the heavy load or whether the GPU temperature is higher than the threshold value. Nevertheless, the number of stream processors to be enabled can be decided according to other mechanisms. The operating mode controlling method and the graphics processing unit of the present invention can cooperate with other conventional power-saving means (e.g. reduction of working clock or operating voltage) in order to enhance the power-saving efficacy.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operating mode controlling method for use with a graphics processing unit of a computer system, the graphics processing unit comprising a plurality of stream processors, the operating mode controlling method comprising steps of:
detecting an operating status of the computer system to determine a normal-operating mode or a power-saving mode of the graphics processing unit;
enabling all of the stream processors if the graphics processing unit is operated in the normal-operating mode; and
enabling some of the stream processors if the graphics processing unit is operated in the power-saving mode.

2. The operating mode controlling method according to claim 1 wherein the number of stream processors to be enabled or disabled is decided according to settings through a register.

3. The operating mode controlling method according to claim 1 wherein the graphics processing unit is operated in the normal-operating mode when a 3D multimedia processing operation is performed, and the graphics processing unit is operated in the power-saving mode when the 3D multimedia processing operation is not performed.

4. The operating mode controlling method according to claim 1 wherein the graphics processing unit is operated in the normal-operating mode when a central processing unit of the computer system is under a heavy load, and the graphics processing unit is operated in the power-saving mode when the central processing unit is under a light load.

5. The operating mode controlling method according to claim 1 wherein the graphics processing unit is operated in the normal-operating mode when the temperature of the graphics processing unit is higher than a threshold value, and the graphics processing unit is operated in the power-saving mode when the temperature of the graphics processing unit is lower than a threshold value.

6. The operating mode controlling method according to claim 1 wherein the step detecting the operating status of the computer system to determine the normal-operating mode or the power-saving mode of the graphics processing unit comprises sub-steps of:
displaying the operating status of the computer system;
creating a user interface; and
setting the number of stream processors to be enabled in the normal-operating mode and the power-saving mode via the user interface.

7. A graphics processing unit of a computer system, the graphics processing unit comprising:
an input assembler for receiving a graphics data and dividing the graphics data into a plurality of threads;
a thread execution managing unit for receiving and managing the plurality of threads;
a plurality of stream processors connected with the thread execution managing unit, wherein a specified number of stream processors are enabled according to an operating status of the computer system, and the threads from the thread execution managing unit are received and processed by the enabled stream processors, thereby outputting processed graphics data;
a plurality of parallel data caches connected with respective stream processors for temporarily storing the processed graphics data outputted from the stream processors;
a load/store unit for receiving the processed graphics data; and
a frame buffer connected with the load/store unit.

8. The graphics processing unit according to claim 7 wherein the threads include Vtx thread issues, Geom thread issues and Pixel thread issues.

9. The graphics processing unit according to claim 7 wherein all of the stream processors are enabled if the graphics processing unit is operated in the normal-operating mode, and some of the stream processors are enabled if the graphics processing unit is operated in the power-saving mode.

10. The graphics processing unit according to claim 7 wherein graphics processing unit further includes a register, so that the number of stream processors to be enabled or disabled is decided according to settings through the register.

11. The graphics processing unit according to claim 9 wherein the graphics processing unit is operated in the normal-operating mode when a 3D multimedia processing operation is performed, and the graphics processing unit is operated in the power-saving mode when the 3D multimedia processing operation is not performed.

12. The graphics processing unit according to claim 9 wherein the graphics processing unit is operated in the normal-operating mode when the temperature of the graphics processing unit is higher than a threshold value, and the graphics processing unit is operated in the power-saving mode when the temperature of the graphics processing unit is lower than a threshold value.

13. The graphics processing unit according to claim 9 wherein a user interface is created according to the operating status of the computer system, and the numbers of stream processors to be enabled in the normal-operating mode and the power-saving mode are set via the user interface.
